(19) United States
(12) Patent Application Publication
(10) Pub. No.: US 2026/0192915 A1
(43) Pub. Date: Jul. 9, 2026

(54) TRI-WING, HYBRID VERTICAL TAKE-OFF AND LANDING AIRCRAFT

(71) Applicants: BEIHANG UNIVERSITY, Beijing (CN); TIANMUSHAN LABORATORY, Hangzhou (CN)

(72) Inventors: Longfei ZHAO, Beijing (CN); Zongxia JIAO, Beijing (CN); Wuyao JIANG, Beijing (CN); Jingfeng XIE, Beijing (CN); Jinhao LOU, Beijing (CN); Haishan HUANG, Hangzhou (CN); Xufei YAN, Hangzhou (CN); Zhaotong CHEN, Beijing (CN); Jixiang LIANG, Beijing (CN); Pengfei KANG, Beijing (CN)

(21) Appl. No.: 19/553,544

(22) Filed: Mar. 2, 2026

Related U.S. Application Data
(63) Continuation of application No. PCT/CN2024/121467, filed on Sep. 26, 2024.

(30) Foreign Application Priority Data
Oct. 7, 2023 (CN) 202311299685X

(51) Int. Cl. B64C 29/00; B64C 25/36; B64C 25/52; B64C 25/54; B64C 39/08; B64D 27/02; B64D 27/31

(52) U.S. Cl. CPC B64C 29/0025; B64C 25/36; B64C 25/52; B64C 25/54; B64C 39/08; B64D 27/026; B64D 27/31

(57) ABSTRACT

The present disclosure discloses a tri-wing hybrid vertical take-off and landing aircraft, including a tilting body fuselage, a front wing assembly, a middle wing assembly, and a rear wing assembly. The front, middle, and rear wing assemblies are sequentially arranged along the longitudinal direction of the tilting body fuselage. The front, middle, and rear wing assemblies are provided in pairs, symmetrically arranged on both sides of the tilting body fuselage. Specifically, the front wing assembly includes a front wing body, a first power unit, and a first pontoon mechanism. The front wing body is fixedly connected to the tilting body fuselage, and the first pontoon mechanism is mounted below the front wing body. The first power unit is mounted on the front wing body and, in a parked state, is in a tilted position to provide the moment required for tilting the fuselage upward. The present disclosure enables easier lifting during the take-off phase.

This application is a continuation application of PCT application No. PCT/CN 2024/121467, filed on Sep. 26, 2024, which claims priority to the Chinese patent application filed with the China Patent Office on Oct. 7, 2023, with the application number 202311299685.X and the title “TRI-WING, HYBRID VERTICAL TAKE-OFF AND LANDING AIRCRAFT”, the entire contents of which are incorporated into this application by reference.

### FIELD

The present disclosure relates to the field of aerospace technology, and specifically to a tri-wing hybrid vertical take-off and landing (VTOL) aircraft.

### BACKGROUND

To achieve an organic integration of VTOL and efficient horizontal flight, VTOL Fixed-Wing Aircraft currently adopt the following configuration schemes: a compound wing configuration where the fixed-wing serves as the primary structure, with an integrated multi-rotor module for take-off and landing; a tilt-rotor configuration where some or all of the rotors of the fixed-wing aircraft can tilt, during take-off and landing phases, the rotors operate in the horizontal plane to provide lift, while during level flight, some or all of the rotors tilt to the longitudinal axis of the aircraft to provide thrust; a tail-sitter configuration where during take-off and landing, the aircraft points upward, and the entire airframe tilts to transition between flight phases. The self-tilting body VTOL aircraft achieves full-airframe tilting through differential control of distributed propulsion and a specially designed belly contour or skid. Compared to the compound configuration, the additional drag from the VTOL power unit is reduced. In contrast to tilt-rotor and tilting-wing configurations, it has no mechanical tilting mechanisms, resulting in a simpler aircraft structure and lighter weight.

The tri-wing configuration is commonly found in compound VTOL aircraft. Its main wing, canard, and horizontal tail are positioned essentially on the same horizontal plane, as shown in patents CN211685619U and CN107571994B. The front and rear surfaces primarily serve to connect and trim the pitching moment of the main wing, and do not generate positive lift. Therefore the main wing adopts a large wingspan design similar to conventional fixed-wing aircraft, which imposes certain requirements on the width of take-off and landing sites. For instance, as shown in patent CN211685619U, when used for water take-off and landing, the large wingspan design is not conducive to coping with wavy water conditions. Patent CN115230963A describes a tri-wing configuration aircraft based on a tilting ducted fan design, where all three surfaces generate positive lift, sharing the aerodynamic load of the main wing. This enhances the aircraft's stability and reduces structural weight. The vertical distribution of the wings is as follows: the middle wing is the highest, the front wing is next, and the rear wing is the lowest. Consequently, during level flight, the rear wing is immersed in the downwash from the middle wing, leading to degraded aerodynamic performance of the rear wing.

Furthermore, for VTOL fixed-wing aircraft, high-power propulsion units are required to generate lift during take-off and landing, and during these phases, distributed propulsion units with high dynamic response are utilized to generate attitude control forces, while power consumption is relatively low when cruising in fixed-wing mode. The hybrid power approach for VTOL aircraft is typically illustrated in patents CN212797308U and CN112046764B.

Self-tilting body VTOL aircraft are equipped with an arched belly curve or skids to accommodate their unique “tumbling” take-off and landing method. For example, an aircraft uses an arched belly curve to achieve a smooth transition during take-off and landing, for example, patent CN115503952A employs “splay-shaped” skids to realize this process.

The arched belly design of a self-tilting body VTOL aircraft not only meets the posture change requirements during self-tilting take-off and landing but also, if used for water operations, the protruding belly acts as a pontoon to ensure that components such as the power unit remain above the water surface. However, this aircraft has not actually undergone water take-off and landing verification. Although the arched fuselage can serve as a pontoon providing substantial displacement, its narrow tail has limited displacement capacity. According to preliminary simulations of this disclosure, during vertical descent, the tail, including the rear wing, would be completely submerged in water.

Existing self-tilting body VTOL aircraft, including a certain aircraft and patent CN115503952A, adopt a two-surface configuration. To facilitate the “tumbling” motion, the aircraft's center of gravity needs to be relatively aft. Considering static stability requirements, the wingspan of the rear wing must be increased, which brings a series of negative impacts: higher demands on the width of the take-off and landing site, and a significant risk of the rear wing touching the ground during take-off and landing. Therefore, the center of gravity in the two-surface configuration can only be positioned as far forward as possible, approximately midway between the two wings. This results in a shorter force arm for the front wing's thrust, making it more difficult for the self-tilting aircraft to perform the “tumbling” motion.

A feasible solution is presented in patent CN115503952A, which involves the front wing generating forward thrust while the rear wing's propeller reverses at the moment of “tumbling” to create reverse thrust. This forms a force couple between the front and rear wings. Once the aircraft is vertical, the rear wing's propeller reverses, and together with the front wing, generates thrust to lift the aircraft off the ground. However, this subjects the rear wing's power system to severe alternating loads, significantly reducing the lifespan of components such as motors.

In summary, existing aircraft designs struggle to meet the requirements of specialized water take-off and landing scenarios. How to enhance the endurance of VTOL aircraft and how to make self-tilting body VTOL aircraft easier to take off are critical issues that need to be addressed in this field.

### SUMMARY

The present disclosure aims to provide a tri-wing hybrid VTOL aircraft to address the deficiencies in existing technologies, which enables easier lifting during take-off, extends endurance, and offers improved adaptability to water take-off and landing.

The present disclosure provides a tri-wing hybrid VTOL aircraft, including: a tilting body fuselage, a front wing assembly, a middle wing assembly, and a rear wing assembly; the front wing assembly, the middle wing assembly, and the rear wing assembly are sequentially arranged along a longitudinal direction of the tilting body fuselage and mounted on the tilting body fuselage; the front wing assembly, the middle wing assembly, and the rear wing assembly are each provided in two sets, symmetrically arranged on both sides of the tilting body fuselage.

The front wing assembly includes a front wing body, a first power unit, and a first pontoon mechanism; the front wing body is fixedly connected to the tilting body fuselage, the first pontoon mechanism is mounted below the front wing body, and the first power unit is mounted on the front wing body.

The first power unit is mounted on the front wing body and, in a parked state, is in a tilted position to provide a moment for tilting the tilting body fuselage upward.

The tri-wing hybrid VTOL aircraft as described above, optionally in a level flight state, the front wing assembly, the middle wing assembly, and the rear wing assembly are arranged sequentially from low to high along a fuselage height direction.

The tri-wing hybrid VTOL aircraft as described above, optionally further includes: a connecting wing which connects the middle wing assembly and the rear wing assembly on a same side of the tilting body fuselage; the connecting wing is inclined outward along a front-to-rear direction.

The tri-wing hybrid VTOL aircraft as described above, optionally the first pontoon mechanism includes a load-bearing support, a pontoon body, a telescopic member, and a pontoon wheel.

An upper end of the load-bearing support is connected to the front wing body, and a lower end of the load-bearing support is connected to the pontoon body; a lower end of the telescopic member is hinged to the pontoon wheel, and an upper end of the telescopic member is hinged to the front wing body.

The tri-wing hybrid VTOL aircraft as described above, optionally the middle wing assembly includes a middle wing body and a second power unit.

The second power unit is mounted on the middle wing body.

The center of gravity of the aircraft is located in a plane of the middle wing body.

The tri-wing hybrid VTOL aircraft as described above, optionally the middle wing assembly further includes a second pontoon mechanism.

The second pontoon mechanism is mounted on the bottom of the middle wing body.

The tri-wing hybrid VTOL aircraft as described above, optionally the rear wing assembly includes a rear wing body and a third power unit.

The third power unit is mounted on the rear wing body.

The tri-wing hybrid VTOL aircraft as described above, optionally along the longitudinal direction of the tilting body fuselage, a distance between the front wing body and the middle wing body is greater than a distance between the middle wing body and the rear wing body.

The tri-wing hybrid VTOL aircraft as described above, optionally at least one of the front wing body, the middle wing body, or the rear wing body is equipped with a control surface.

The tri-wing hybrid VTOL aircraft as described above, optionally lengths of the front wing body, the middle wing body, and the rear wing body increase sequentially.

The tri-wing hybrid VTOL aircraft as described above, optionally the front wing body has an anhedral angle of 6-8 degrees, the middle wing body has a dihedral angle of 7-9 degrees, and the rear wing body has a dihedral angle of 6-8 degrees.

The tri-wing hybrid VTOL aircraft as described above, optionally the front wing body has a sweepback angle of 7-13 degrees, the middle wing body has a sweepback angle of 15 to 25 degrees, and the rear wing body has a sweepback angle of −5 to 5 degrees.

The tri-wing hybrid VTOL aircraft as described above, optionally the first power unit, the second power unit, and the third power unit each include a power device and a propeller.

The power devices of the first power unit and the second power unit are electric power units, and the power device of the third power unit is a hydrogen power unit or a fuel power unit; or the power devices of the first power unit and the second power unit are hydrogen power units or fuel power units, and the power device of the third power unit is an electric power unit.

Compared with existing technologies, the tri-wing tilting body proposed in the present disclosure tilts up more easily than the two-surface configuration. Under the same take-off weight, the tri-wing design has a smaller wingspan than the two-surface tilting configuration, resulting in a more compact spatial volume, which facilitates direct transportation by ships, containers, and trucks, while also reducing the required width of take-off and landing sites. The power arrangement of the tri-wing design allows for more flexible hybrid power configurations. Existing two-surface tilting configurations are equipped with four power units on the front and rear wings respectively. To ensure the thrust line passes through the center of gravity during level flight and maintain left-right symmetry, there are two approximate hybrid power arrangements: the inner four power units adopt fuel (or hydrogen) power units while the outer four power units adopt electric power units, or vice versa. In contrast, the tri-wing configuration can either have the two power units on the middle wing adopt fuel (or hydrogen), or the four power units on the front and rear wings adopt fuel (or hydrogen), adapting to different level-flight power requirements and offering greater flexibility compared to the two-surface design. If a connecting wing is implemented in a two-surface configuration, the length of this connecting wing is relatively large, requiring a significant structural weight penalty to achieve the goal of enhancing airframe stiffness. The tri-wing design, however, can realize the connecting wing structure with a lower weight penalty. The middle and rear wings of the tri-wing configuration form a connecting wing, which improves the structural stiffness on the ground-contact side of the aircraft and is more conducive to absorbing impact during tilt-landing.

### BRIEF DESCRIPTION OF DRAWINGS

FIG. 1 is an axonometric view of the aircraft in level flight attitude according to the present invention;

FIG. 2 is a side view of the aircraft in level flight attitude according to the present invention;

FIG. 3 is a front view of the aircraft in level flight attitude according to the present invention;

FIG. 4 is a top view of the aircraft in level flight attitude according to the present invention;

FIG. 5 is a front view of the aircraft in ground parked state according to the present invention;

FIG. 6 is a side view of the aircraft in ground parked state according to the present invention;

FIG. 7 is a side view of the aircraft in water floating state according to the present invention;

FIG. 8 is a schematic diagram of the take-off process of the aircraft according to the present invention.

### DESCRIPTION OF REFERENCE NUMERALS

1—Tilting body fuselage, 2—Front wing assembly, 3—Middle wing assembly, 4—Rear wing assembly, 5 Connecting wing;
21—Front wing body, 22—First power unit, 23—First pontoon mechanism;
231—Load-bearing support, 232—Pontoon body, 233—Telescopic member, 234—Pontoon wheel;
31—Middle wing body, 32—Second power unit, 33—Second pontoon mechanism;
41—Rear wing body, 42—Third power unit;
51—Landing gear.

### DETAILED DESCRIPTION

The following embodiments described with reference to the accompanying drawings are exemplary and are intended solely to explain the present invention, without being construed as limitations thereto.

In response to the problems identified in the background, the present disclosure proposes the following embodiments as solutions.

### Embodiment 1

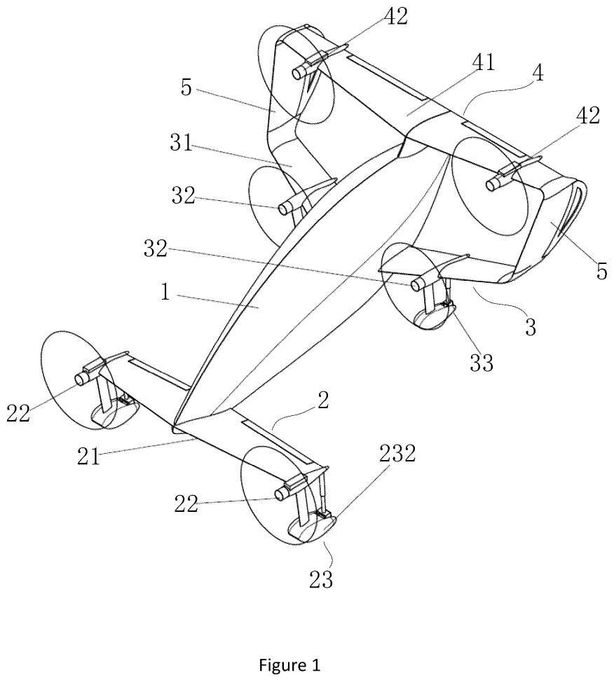

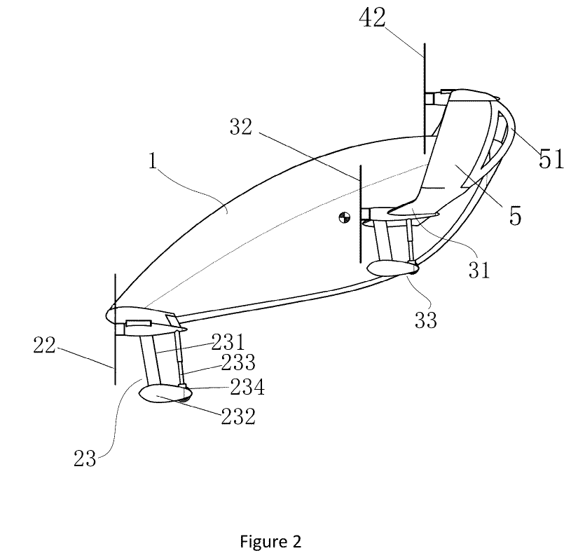

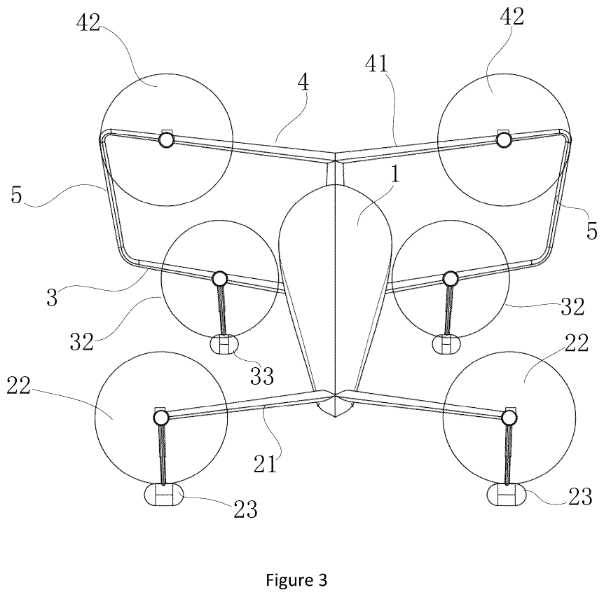

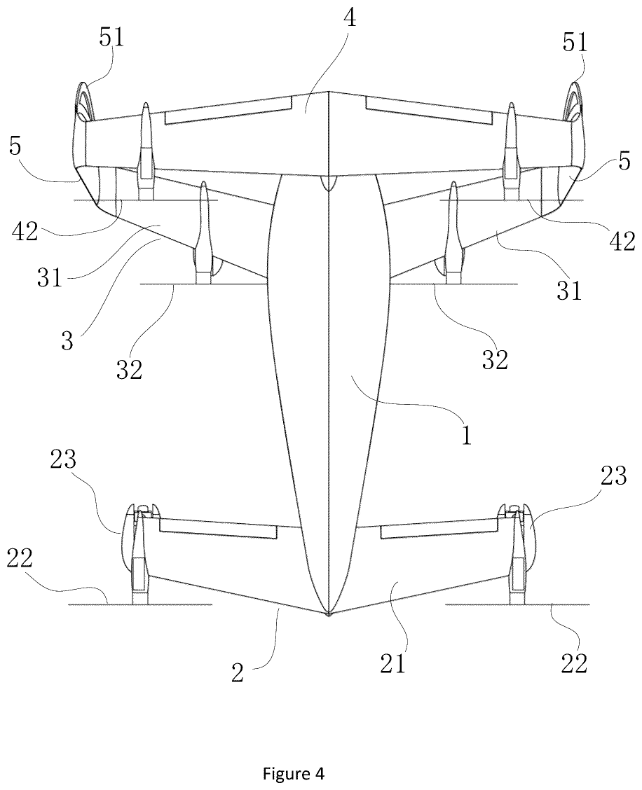

Please refer to FIGS. 1 to 8. This embodiment proposes a tri-wing, hybrid-power VTOL aircraft, including a tilting body fuselage 1, front wing assemblies 2, middle wing assemblies 3, and rear wing assemblies 4. The front wing assemblies 2, the middle wing assemblies 3, and the rear wing assemblies 4 are sequentially arranged along the longitudinal direction of the tilting body fuselage 1 on the fuselage. The front wing assemblies 2, the middle wing assemblies 3, and the rear wing assemblies 4 are provided in pairs, symmetrically arranged on both sides of the tilting body fuselage 1. In a specific implementation, the tilting body fuselage 1 should also be designed as a left-right symmetrical structure. The two front wing assemblies 2 are respectively located on the left and right sides of the tilting body fuselage 1 and are symmetrical to each other. The two middle wing assemblies 3 are respectively located on the left and right sides of the tilting body fuselage 1 and are symmetrical to each other. The two rear wing assemblies 4 are respectively located on the left and right sides of the tilting body fuselage 1 and are symmetrical to each other.

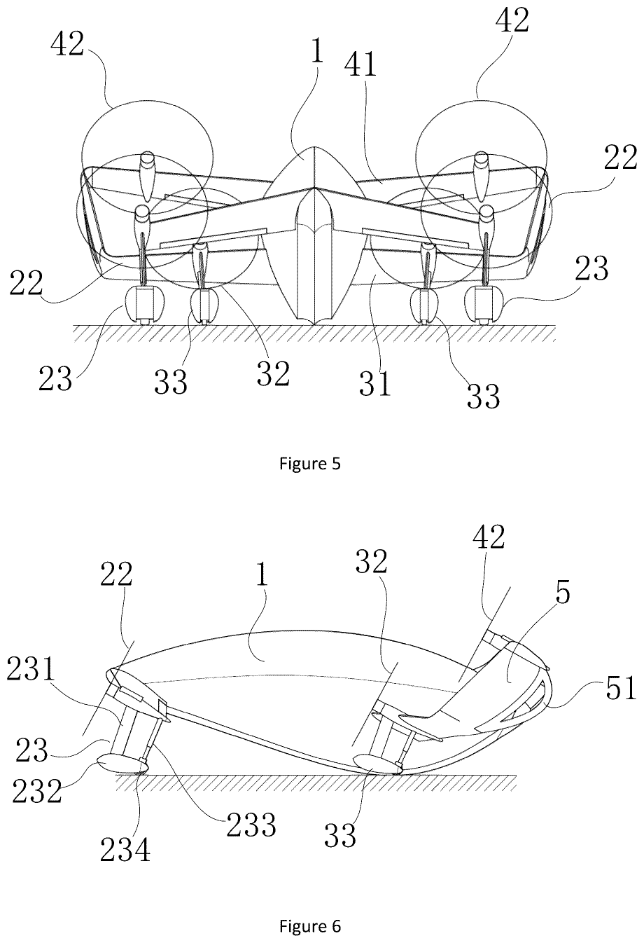

Specifically, the tilting body fuselage 1 integrates a tilting body configuration and a ship-like keel fuselage adapted for water take-off and landing. Please refer to FIGS. 5 and 6. That is, the bottom of the tilting body fuselage 1 is designed with a ship-like keel profile, enabling it to tilt up easily on land while also reducing drag during take-off from water.

The front wing assembly 2 includes a front wing body 21, a first power unit 22, and a first pontoon mechanism 23. The front wing body 21 is fixedly connected to the tilting body fuselage 1, and the first pontoon mechanism 23 is installed below the front wing body 21. The function of the first pontoon mechanism 23 is to position the aircraft at an angle conducive to take-off—that is, with the inclined upward—when parked, whether on land or on water. More specifically, when parked, the centerline of the first power unit 22 is tilted so that when the first power unit 22 is activated, it can provide a force directed obliquely forward and upward. This force generates a moment that prompts the tilting body fuselage 1 to tilt up. The first power unit 22 is mounted on the front wing body 21. Specifically, the first power unit 22 is rotatably mounted on the front wing body 21 and is driven by an engine or an electric motor.

The first power unit 22 is mounted on the front wing body 21. In the parked state, the first power unit 22 is in a tilted orientation to provide a moment capable of lifting the tilting body fuselage 1.

In a specific implementation, in the ground parked state and as shown in FIG. 5, both first pontoon mechanisms 23 and the belly of the tilting body fuselage 1 contact the ground simultaneously. At this point, the first pontoon mechanisms 23 are in a compressed state, and the aircraft maintains a parking angle conducive to take-off.

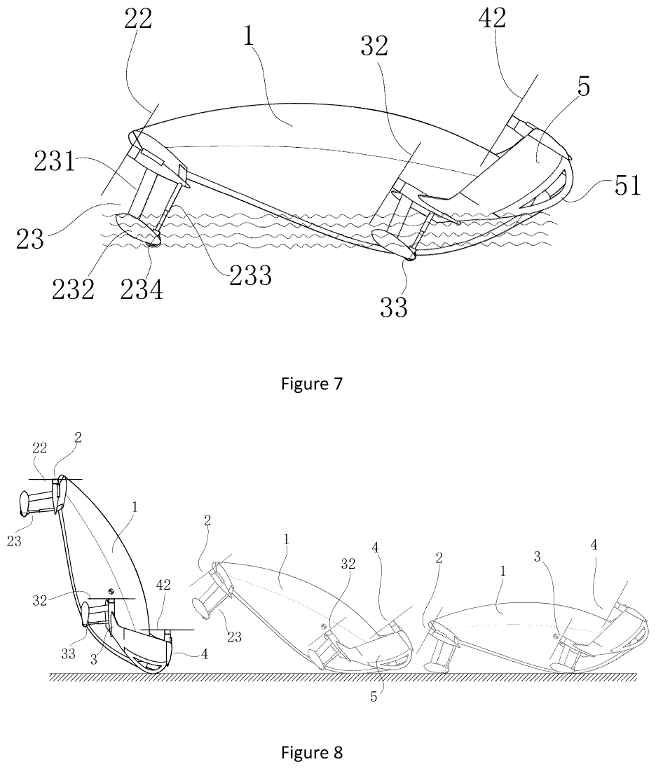

In the waterborne parked state, as shown in FIG. 7, both first float mechanisms 23 and the rear section of the tilting body fuselage 1 are immersed in water. The aircraft maintains a parking angle conducive to take-off, with the first power unit 22 of the front wing assembly 2 positioned well above the water surface. Although the propeller tips of the middle wing assembly 3 may be partially submerged, the tilting process is primarily powered by the first power unit 22 on the front wing assembly 2. During the attitude transition to vertical, the propellers of the middle wing assembly 3 naturally emerge from the water, thus not affecting the take-off.

As illustrated in FIG. 8, the take-off process is as follows: the first power unit 22 of the front wing assembly 2 generates thrust, creating a pitch-up moment about the ground contact point that causes the tilting body fuselage 1 to rotate. The aircraft then “tumbling” along its belly curve. During this process, the damping effect of the first pontoon mechanism 23 is released. This continues until the aircraft attains a vertical attitude. Subsequently, the propellers of the front wing assembly 2, middle wing assembly 3, and rear wing assembly 4 collectively generate thrust to lift the aircraft off the ground. At this stage, the center of gravity of the tri-wing aircraft is located further aft compared to a two-surface tilting aircraft, resulting in a smaller pitch-down moment induced by gravity and thus facilitating easier take-off.

Aircraft hover state: the power units of the front wing assembly 2, middle wing assembly 3, and rear wing assembly 4 simultaneously generate thrust to counterbalance gravity. The pitching moment is generated by the differential thrust between the front wing assembly 2 and the rear wing assembly 4. The yawing moment is produced by the differential thrust between the left and right front wing assemblies 2 and rear wing assemblies 4, and the middle wing assembly 3 does not participate in control. The rolling moment is achieved through control surface deflection on the front wing assembly 2 and rear wing assembly 4. The propeller of the middle wing assembly 3 is a variable-pitch propeller, operating at a low pitch setting during take-off and hover to prevent propeller stall and thrust loss.

Transition from hover to level flight: the thrust of the front wing assembly 2, the middle wing assembly 3, and the rear wing assembly 4 increases, with the rear wing assembly 4 experiencing a greater thrust increase, generating a pitch-down moment around the aircraft's center of gravity and a forward acceleration.

Level flight: the front wing assembly 2 and the rear wing assembly 4 are deactivated, with the middle wing assembly 3 providing the necessary thrust for flight.

Transition from level flight to hover: the front wing assembly 2 and the rear wing assembly 4 are activated, with the thrust of the front wing assembly 2 exceeding that of the rear wing assembly 4, while the thrust of the middle wing assembly 3 is reduced. This generates a pitch-up moment around the aircraft's center of gravity, causing the aircraft to attain a vertical attitude.

Landing process: the overall thrust of the aircraft is gradually reduced, causing the aircraft to descend until the tail landing gear makes contact with the ground. The thrust of the front wing assembly 2, the middle wing assembly 3, and the rear wing assembly 4 is further reduced, with the thrust of the front wing assembly 2 decreasing at a faster rate. Under the influence of gravity, the aircraft slowly pitches forward, rotating around the contact point until the first pontoon mechanism 23 makes contact with the ground.

In a specific implementation, in the level flight state, the front wing assembly 2, the middle wing assembly 3, and the rear wing assembly 4 are arranged sequentially from low to high. The front wing assembly 2, the middle wing assembly 3, and the rear wing assembly 4 are positioned in ascending order and are essentially parallel to each other. This configuration allows for torque generation by adjusting the power output of the front wing assembly 2, the middle wing assembly 3, and the rear wing assembly 4, enabling hover, pitch, tilt, and vertical take-off.

In a specific implementation, it also includes a connecting wing 5, which links the middle wing assembly 3 and the rear wing assembly 4 on the same side of the tilting body fuselage 1. The connecting wing 5 is inclined outward from the front to the rear. Specifically, the connecting wing 5 is used to join the middle wing assembly 3 and the rear wing assembly 4. In detail, there are two connecting wings 5, positioned on the left and right sides of the tilting body fuselage 1, respectively. Each connecting wing 5 connects the middle wing assembly 3 and the rear wing assembly 4 on the same side of the tilting body fuselage 1. More specifically, the connecting wing 5 is attached to the end of the middle wing assembly 3 away from the tilting body fuselage 1 and the end of the rear wing assembly 4 away from the tilting body fuselage 1.

In a specific implementation, the first pontoon mechanism 23 includes a load-bearing support 231, a pontoon body 232, a telescopic member 233, and a pontoon wheel 234. Specifically, the load-bearing support 231 may function as a shock absorber capable of being compressed, while the telescopic member 233 may be a hydraulic rod or an electric telescopic rod.

The upper end of the load-bearing support 231 is connected to the front wing body 21, and the lower end is connected to the pontoon body 232. The lower end of the telescopic member 233 is hinged to the pontoon wheel 234, while the upper end is hinged to the front wing body 21. In a specific implementation, there are also two first pontoon mechanisms 23, that is, one first pontoon mechanism 23 is installed on each front wing assembly 2. The first pontoon mechanism 23 is located at the end of the front wing body 21 or at the position on the front wing body 21 corresponding to the first power unit 22. The two first pontoon mechanisms 23 are symmetrically arranged.

Specifically, the middle wing assembly 3 includes a middle wing body 31 and a second power unit 32. The second power unit 32 is mounted on the middle wing body 31, and the aircraft's center of gravity lies within the plane of the middle wing body 31. The position of the aircraft's center of gravity is related to the propulsion manner during level flight. Depending on the design, when the aircraft is designed to be propelled solely by the second power unit 32 during level flight, it is preferable for the center of gravity to be within the plane of the middle wing body 31. More specifically, the center of gravity should lie within the plane defined by the central axis of the two second power units 32. When the aircraft is designed to be propelled by both the first power unit 22 and the third power unit 42 during level flight, it is preferable for the center of gravity to be located between the front wing body 21 and the rear wing body 41.

The middle wing assembly 3 further includes a second pontoon mechanism 33, which is mounted on the bottom of the middle wing body 31. Specifically, the second pontoon mechanism 33 has the same structure as the first pontoon mechanism 23, that is, it also includes a load-bearing support 231, a pontoon body 232, a telescopic member 233, and a pontoon wheel 234. However, depending on actual requirements, the first pontoon mechanism 23 and the second pontoon mechanism 33 may differ in size. The number of second pontoon mechanisms 33 is also two, and they are symmetrically arranged. Each second pontoon mechanism 33 is located either at the end of the corresponding middle wing body 31 away from the tilting body fuselage 1 or at the position on the middle wing body 31 corresponding to the second power unit 32. In a specific implementation, the second pontoon mechanism 33 provides buoyancy when immersed in water. When the aircraft is stationary on the ground, the second pontoon mechanism 33, together with the first pontoon mechanism 23 and the underside of the tilting body fuselage 1, contacts the ground to form a stable support structure.

In a specific implementation, the rear wing assembly 4 includes a rear wing body 41 and a third power unit 42. The third power unit 42 is mounted on the rear wing body 41. That is, each rear wing assembly 4 is equipped with one third power unit 42, with the two third power units 42 being symmetrically arranged.

In a specific implementation, the propeller of the second power unit 32 utilizes a variable-pitch propeller, operating in low-pitch mode during take-off and landing phases, and switching to high-pitch mode during level flight.

To enable the tilting body fuselage 1 to pitch up more easily, the distance between the front wing body 21 and the middle wing body 31 along the longitudinal direction of the tilting body fuselage 1 is greater than the distance between the middle wing body 31 and the rear wing body 41. In a specific implementation, when the aircraft is stationary on the ground in a non-operational state, the underside of the tilting body fuselage 1 contacts the ground at a position below the middle wing body 31. More specifically, this contact point is located beneath the central axis connecting the two middle wing bodies 31. Configuring the distance between the front wing body 21 and the middle wing body 31 to be greater than that between the middle wing body 31 and the rear wing body 41 facilitates greater torque generation by the first power unit 22 during take-off, allowing the tilting body fuselage 1 to pitch up more readily.

In a specific implementation, at least one of the front wing body 21, the middle wing body 31, and the rear wing body 41 is equipped with control surfaces. This means control surfaces may be installed only on the front wing body 21, the middle wing body 31, or the rear wing body 41; alternatively, they may be installed on any two of these three components, or on all three.

In a preferred implementation, the lengths of the front wing body 21, the middle wing body 31, and the rear wing body 41 increase sequentially.

Furthermore, the anhedral angle of the front wing body 21 ranges from 6 to 8 degrees, specifically 6, 7, or 8 degrees. The dihedral angle of the middle wing body 31 ranges from 7 to 9 degrees, specifically 7, 8, or 9 degrees, while the dihedral angle of the rear wing body 41 ranges from 6 to 8 degrees, specifically 6, 7, or 8 degrees. In one preferred combination, the front wing body 21 has an anhedral angle of 7 degrees, the middle wing body 31 has a dihedral angle of 8 degrees, and the rear wing body 41 has a dihedral angle of 7 degrees. This configuration ensures the lateral stability of the aircraft.

Specifically, the sweepback angle of the front wing body 21 ranges from 7 to 13 degrees. In a specific implementation, it may be 8, 9, 10, 11, or 12 degrees, though other values are also possible. The sweepback angle of the middle wing body 31 ranges from 15 to 25 degrees, for example, 16, 17, 18, 19, 20, 21, 22, 23, or 24 degrees.

Specifically, the power units of the first and second power groups are electric power units, while the power unit of the third power group is a hydrogen or fuel power unit. Alternatively, the power units of the first and second power groups are hydrogen or fuel power units, while the power unit of the third power group is an electric power unit.

For aircraft equipped with folding propellers, during level flight, the folding propellers on the front wing assembly 2 and the rear wing assembly 4 fold backward to reduce aerodynamic drag. The required thrust is provided by the fuel or hydrogen power unit of the middle wing assembly 3, with the propeller of the second power unit 32 being a variable-pitch type that switches to high pitch during level flight to enhance propeller efficiency. During level flight, pitch moments are generated by the control surfaces of the front wing body 21 and rear wing body 41, roll moments by the control surfaces of the front wing body 21 and rear wing body 41, and yaw moments by the differential thrust of the left and right power units in the middle wing assembly 3. In this configuration, the thrust line of the middle wing assembly 3 passes through the aircraft's center of gravity, ensuring no additional pitch moment is generated. The middle wing assembly 3 includes an integrated generator that can recharge the batteries during this phase. Thus, the aircraft only needs to carry batteries sufficient for takeoff, with the power required for landing supplied by the generator during level flight. Considering safety, the power generation function provides ample power reserves.

The landing procedure is as follows: the overall thrust of the aircraft is gradually reduced, causing the aircraft to descend until the tail and the landing gear on the connecting wings make contact with the ground. The thrust of the front, middle, and rear wing assemblies is further reduced, with the front wing assembly's thrust decreasing at a faster rate. The aircraft slowly pitches down under gravity, rotating forward around the contact point. During this process, the pontoon wheels 234 of the middle wing assembly touch down first, compressing the load-bearing support 231, followed by the pontoon wheels 234 under the front wing assembly 2, which also compress their load-bearing support 231. The connecting wings 5 between the middle wing body 31 and rear wing body 41 enhance the structural stiffness of the aircraft, providing greater tolerance for potential emergency or rough landings. Additionally, the landing gear on the connecting wings 5 has a wide lateral span, offering better support during landing.

To facilitate take-off and landing, the connecting wings 5 are equipped with rearward-protruding landing gear 51, featuring an arc-shaped structure on the rear side.

### Embodiment 2

This embodiment represents further improvements based on Embodiment 1. Similar aspects are not repeated here, and only differences are described below.

The key difference from Embodiment 1 lies in the configuration of the power units. In this embodiment, the first power unit is an electric power unit, while the second power unit is a hydrogen or fuel power unit.

That is, the second power unit 32 is powered by an electric unit, while the first power unit 22 and third power unit 42 are powered by fuel or hydrogen power units.

Accordingly, the aircraft's center of gravity position is adjusted to lie between the plane of the front wing body 21 and the plane of the rear wing body 41. During level flight, thrust is provided by the first and third power units, while the batteries are simultaneously recharged. In specific implementations, the electric power unit includes a motor controller and a motor, with the motor driving the propeller. The fuel power unit includes an engine that drives the propeller, with additional structures such as reducers added if necessary.

It should be noted that in the above embodiments, directional references (front, rear, left, right) correspond to the aircraft's orientation.

The construction, features, and effects of the invention have been described in detail above with reference to the illustrated embodiments. The foregoing represents only preferred embodiments of the invention, which is not limited by the drawings. All modifications made based on the concept of the invention, or equivalent changes that fall within the spirit covered by the description and drawings, shall remain under the protection scope of the invention.

What is claimed is:

1. A tri-wing hybrid vertical take-off and landing aircraft, comprising:
a tilting body fuselage (1), a front wing assembly (2), a middle wing assembly (3), and a rear wing assembly (4); the front wing assembly (2), the middle wing assembly (3), and the rear wing assembly (4) are sequentially arranged along a longitudinal direction of the tilting body fuselage (1) and mounted on the tilting body fuselage (1); the front wing assembly (2), the middle wing assembly (3), and the rear wing assembly (4) are each provided in two sets, symmetrically arranged on both sides of the tilting body fuselage (1);
wherein the front wing assembly (2) comprises a front wing body (21), a first power unit (22), and a first pontoon mechanism (23); the front wing body (21) is fixedly connected to the tilting body fuselage (1), the first pontoon mechanism (23) is mounted below the front wing body (21), and the first power unit (22) is mounted on the front wing body (21);
the first power unit (22) is mounted on the front wing body (21) and, in a parked state, is in a tilted position to provide a moment for tilting the tilting body fuselage (1) upward.

2. The tri-wing hybrid vertical take-off and landing aircraft according to claim 1, wherein in a level flight state, the front wing assembly (2), the middle wing assembly (3), and the rear wing assembly (4) are arranged sequentially from low to high along a fuselage height direction.

3. The tri-wing hybrid vertical take-off and landing aircraft according to claim 2 further comprises: a connecting wing (5) which connects the middle wing assembly (3) and the rear wing assembly (4) on a same side of the tilting body fuselage (1); the connecting wing (5) is inclined outward along a front-to-rear direction.

4. The tri-wing hybrid vertical take-off and landing aircraft according to claim 1, wherein the first pontoon mechanism (23) comprises a load-bearing support (231), a pontoon body (232), a telescopic member (233), and a pontoon wheel (234);
an upper end of the load-bearing support (231) is connected to the front wing body (21), and a lower end of the load-bearing support (231) is connected to the pontoon body (232); a lower end of the telescopic member (233) is hinged to the pontoon wheel (234), and an upper end of the telescopic member (233) is hinged to the front wing body (21).

5. The tri-wing hybrid vertical take-off and landing aircraft according to claim 1, wherein the middle wing assembly (3) comprises a middle wing body (31) and a second power unit (32);
the second power unit (32) is mounted on the middle wing body (31); the center of gravity of the aircraft is located in a plane of the middle wing body (31).

6. The tri-wing hybrid vertical take-off and landing aircraft according to claim 5, wherein the middle wing assembly (3) further comprises a second pontoon mechanism (33);
the second pontoon mechanism (33) is mounted on the bottom of the middle wing body (31).

7. The tri-wing hybrid vertical take-off and landing aircraft according to claim 5, wherein the rear wing assembly (4) comprises a rear wing body (41) and a third power unit (42);
the third power unit (42) is mounted on the rear wing body (41).

8. The tri-wing hybrid vertical take-off and landing aircraft according to claim 7, wherein along the longitudinal direction of the tilting body fuselage (1), a distance between the front wing body (21) and the middle wing body (31) is greater than a distance between the middle wing body (31) and the rear wing body (41).

9. The tri-wing hybrid vertical take-off and landing aircraft according to claim 7, wherein at least one of the front wing body (21), the middle wing body (31), or the rear wing body (41) is equipped with a control surface.

10. The tri-wing hybrid vertical take-off and landing aircraft according to claim 7, wherein lengths of the front wing body (21), the middle wing body (31), and the rear wing body (41) increase sequentially.

11. The tri-wing hybrid vertical take-off and landing aircraft according to claim 7, wherein the front wing body (21) has an anhedral angle of 6-8 degrees, the middle wing body (31) has a dihedral angle of 7-9 degrees, and the rear wing body (41) has a dihedral angle of 6-8 degrees.

12. The tri-wing hybrid vertical take-off and landing aircraft according to claim 7, wherein the front wing body (21) has a sweepback angle of 7-13 degrees, the middle wing body (31) has a sweepback angle of 15 to 25 degrees, and the rear wing body (41) has a sweepback angle of −5 to 5 degrees.

13. The tri-wing hybrid vertical take-off and landing aircraft according to claim 1, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

14. The tri-wing hybrid vertical take-off and landing aircraft according to claim 2, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

15. The tri-wing hybrid vertical take-off and landing aircraft according to claim 3, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

16. The tri-wing hybrid vertical take-off and landing aircraft according to claim 4, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

17. The tri-wing hybrid vertical take-off and landing aircraft according to claim 5, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

18. The tri-wing hybrid vertical take-off and landing aircraft according to claim 6, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

19. The tri-wing hybrid vertical take-off and landing aircraft according to claim 7, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.

20. The tri-wing hybrid vertical take-off and landing aircraft according to claim 8, wherein the first power unit (22), the second power unit (32), and the third power unit (42) each comprise a power device and a propeller;
the power devices of the first power unit (22) and the second power unit (32) are electric power units, and the power device of the third power unit (42) is a hydrogen power unit or a fuel power unit; or
the power devices of the first power unit (22) and the second power unit (32) are hydrogen power units or fuel power units, and the power device of the third power unit (42) is an electric power unit.
